(19) United States
(12) Patent Application Publication
(10) Pub. No.: US 2025/0077978 A1
(43) Pub. Date: Mar. 6, 2025

(54) DATA PROCESSING METHOD AND APPARATUS, DEVICE

(71) Applicant: MaShang Consumer Finance Co., Ltd., Chongqing (CN)

(72) Inventor: Changlin LI, Chongqing (CN)

(21) Appl. No.: 18/949,837

(22) Filed: Nov. 15, 2024

(30) Foreign Application Priority Data
Dec. 12, 2023 (CN) 202311706388.2

(51) Int. Cl. G06N 20/00

(52) U.S. Cl. CPC G06N 20/00

(57) ABSTRACT

An embodiment of the present application provides a data processing method, apparatus, and device, where the method includes: obtaining a to-be-processed target matrix, generating first evaluation data of the target matrix according to position information of the eigenvalue in the target matrix and the eigenvalue, the eigenvalue included in the target matrix, generating second evaluation data of the target matrix according to eigenvalue constraint information and the eigenvalue included in the target matrix, performing a sparsity evaluation on the target matrix according to the first evaluation data and the second evaluation data. Through the embodiment of the present application, an accuracy of a matrix sparsity evaluation can be improved.

### CROSS-REFERENCE TO RELATED APPLICATIONS

This application claims priority to Chinese Patent Application No. 202311706388.2, filed on Dec. 12, 2023, which is hereby incorporated by reference in its entirety.

### TECHNICAL FIELD

Embodiments of the present disclosure relate to the field of artificial intelligent processing technology and, in particular, to a data processing method, a data processing apparatus and a device.

### BACKGROUND

In a process of machine learning, data features are usually stored through a matrix, and the matrix is used as training data for model training processing. In some scenarios, the number of zero-value elements in the matrix is much greater than the number of non-zero elements, and this matrix can be called a sparse matrix. For example, in the field of e-commerce, there are thousands of products. Since it is impossible for each customer to purchase all the products once, a purchase record of the customer is only the purchase record for small part of the massive number of products. When the elements in the matrix represent the number of products purchased by a user, in the matrix generated based on the purchase records of multiple customers, the number of zero-value elements will be much greater than the number of non-zero elements, that is, the generated matrix is the sparse matrix. If the sparse matrix is determined as the training data and the model training is performed, it will not only increase a learning difficulty of the model, but also reduce model performance.

### SUMMARY

The present application provides a data processing method, an apparatus, and a device to enhance an effectiveness of a matrix sparsity evaluation, thereby providing training data in a matrix form that easy to learn for machine learning, reducing a learning difficulty for model learning, and improving model performance.

In a first aspect, an embodiment of the present application provides a data processing method, including:
obtaining a matrix, the matrix includes an eigenvalue corresponding to a data feature;
generating first evaluation data of the matrix according to the eigenvalue r and position information of the eigenvalue in the matrix, the first evaluation data being dispersion of the eigenvalue in terms of distribution;
generating second evaluation data of the matrix according to the eigenvalue and constraints of the eigenvalue, the second evaluation data being a degree of approaching zero of the eigenvalue in terms of numerical;
performing a sparsity evaluation on the matrix according to the first evaluation data and the second evaluation data.

It can be seen that, in an embodiment of the present application, when the matrix is obtained, the first evaluation data of the matrix is generated according to the position information of the eigenvalue in the matrix and the eigenvalue; the second evaluation data of the matrix is generated according to the constraints of the eigenvalue and the eigenvalue included in the matrix; and the sparsity evaluation is performed on the matrix according to the first evaluation data and the second evaluation data. Due to the fact that the first evaluation data being the dispersion of the eigenvalue included in the matrix in terms of distribution, while the second evaluation data being the degree to approaching zero of the eigenvalue included in the matrix in terms of numerical; therefore, not only an influence of zero eigenvalues (i.e., the eigenvalue with a value being zero) on a matrix sparsity is considered, but also the influence of non-zero eigenvalues (i.e., the eigenvalue with the value being non-zero) on the matrix sparsity is taken into account, and the dispersion of an overall distribution of respective eigenvalues in the matrix and the overall degree of approaching zero can be accurately measured; thus the effectiveness of the matrix sparsity evaluation is greatly improved. In the field of machine learning, when the training data is in a matrix form, the training data in the matrix form can be effectively evaluated based on this effective evaluation method for the matrix sparsity, thereby filtering out the training data that is easy to learn for the machine learning, reducing the learning difficulty for the model, and improving the model performance.

In a second aspect, an embodiment of the present application provides a data processing apparatus, including:
an obtaining module, configured to obtain a matrix, the matrix includes an eigenvalue corresponding to a data feature;
a generating module, configured to generate first evaluation data of the matrix according to the eigenvalue and position information of the eigenvalue in the matrix, the first evaluation data being dispersion of the eigenvalue in terms of distribution;
the generation module is further configured to generate second evaluation data of the matrix according to the eigenvalue and constraints of the eigenvalue, the second evaluation data being a degree of approaching zero of the eigenvalue in terms of numerical;
an evaluating module, configured to perform a sparsity evaluation on the matrix according to the first evaluation data and the second evaluation data.

In a third aspect, an embodiment of the present application provides an electronic device, including:
a processor; and a memory arranged to store computer executable instructions, where the executable instructions are configured to be executed by the processor, and the executable instructions include steps for executing the data processing method provided in the first aspect.

In a fourth aspect, an embodiment of the present application provides a storage medium, where the storage medium is configured to store computer executable instructions, and the executable instructions enable a computer to execute the data processing method provided in the first aspect.

### BRIEF DESCRIPTION OF DRAWINGS

In order to provide a clearer explanation of technical solutions in one or more embodiments in the present application or the prior art, a brief introduction will be given below to accompanying drawings required in describing the embodiments or prior art. It is evident that, the accompanying drawings in the following description are only some of the embodiments described in the present application. For those skilled in the art, other accompanying drawings can be obtained based on these accompanying drawings without requiring creative labor.

FIG. 1 is a first flowchart diagram of a data processing method provided by an embodiment of the present application.

FIG. 2 is a second flowchart diagram of a data processing method provided by an embodiment of the present application.

FIG. 3 is a third flowchart diagram of a data processing method provided by an embodiment of the present application.

FIG. 4 is a fourth flowchart diagram of a data processing method provided by an embodiment of the present application.

FIG. 5 is a module composition diagram of a data processing apparatus provided by an embodiment of the present application.

FIG. 6 is a structural diagram of an electronic device provided by an embodiment of the present application.

### DESCRIPTION OF EMBODIMENTS

In order to enable those skilled in the art to better understand technical solutions in one or more embodiments of the present application, the following will provide a clear and complete description of the technical solutions in one or more embodiments of the present application in conjunction with the accompanying drawings in one or more embodiments of the present application. Clearly, the described embodiments are only a part of the embodiments of the present application, not all of them. Based on one or more embodiments of the present application, all other embodiments obtained by those ordinary skilled in the art without creative labor shall fall within a protection scope of this document.

For a matrix, when the number of zero-value elements (i.e., an element with an element value being zero) in the matrix is much greater than the number of non-zero elements (i.e., the element with the element value being non-zero), and a distribution of the non-zero elements is irregular, this matrix can be called a sparse matrix; on the contrary, this matrix can be called a dense matrix. There are many application scenarios and generation reasons for the sparse matrix. For example, in the field of e-commerce, there are thousands of products. As each customer objectively cannot purchase all the products once, a purchase record of the customer is inevitably only the purchase record for a small part of the massive products. Therefore, the purchase records of multiple customers can form one sparse matrix. For another example, in the field of text mining, in order to compare whether several articles belong to the same topic, a batch of keywords are first selected, and then frequencies of these keywords appearing in each article are compared to make a judgment. This batch of keywords may have thousands, and each article may only include dozens to hundreds of them, so a resulting matrix is also one sparse matrix. For yet another example, in a word vector representation, the sparse matrix may be generated; such as an article may include hundreds or thousands of different words, so a vector representation dimension of each word is hundreds or thousands of dimensions. When using the one-hot method to represent words, in the word vector corresponding to each word, only position of this word is 1, and all other positions are 0, thus the vectors of these words form the sparse matrix. At present, in the process of machine learning, data features are usually stored through the matrix, and this matrix is used as training data for model training processing and optimization calculation. However, when the matrix is the sparse matrix, due to a majority of the zero-value elements, that is a separability between corresponding features is not obvious, it will increase a learning difficulty of a model and reduce model performance. To solve this technical problem, one of the existing techniques is to count the number of zeroes included in the matrix. However, this method cannot compare the sparsity of the matrices in different dimensions, and also ignores an impact of the distribution of other element values. For example, matrices

$$[ \begin{matrix}0 & 1 \\ 0 & 1\end{matrix} ]$$

and

$$[ \begin{matrix}0 & 1 & 2 \\ 2 & 0 & 3\end{matrix} ]$$

include the same number of zero-value elements, the sparsity of the two matrices is the same according to this method, but this is obviously incorrect. Another processing method in existing technology is to count a proportion of zero-value elements in the matrix; that is, dividing the number of zero-value elements by the total number of elements in the matrix. However, this method only considers the zero-value elements and ignores the impact of the distribution of other element values; such as matrices

$$[ \begin{matrix}0 & 1 \\ 0 & 1\end{matrix} ]$$

and

$$[ \begin{matrix}0 & 1 \\ 2 & 0\end{matrix} ] ,$$

the sparsity of the two matrices is the same according to this method, which is obviously incorrect. Another method in existing technology is to calculate a ratio of a mean value to the maximum value of matrix elements, but this method does not take into account an influence of extremely values of the element and also ignores the influence of the distribution of element values; such as matrices

$$[ \begin{matrix}0 & 16 & 1 \\ 1 & 0 & 0\end{matrix} ]$$

and

$$[ \begin{matrix}0 & 5 & 6 \\ 7 & 0 & 0\end{matrix} ] ,$$

the sparsity of the two matrices is the same according to this method, which is clearly an incorrect conclusion. It can be seen that there is currently no effective evaluation method for the matrix sparsity. Based on this, an embodiment of the present application provides a data processing method, when a to-be-processed target matrix is obtained, first evaluation data of the target matrix is generated according to position information in the target matrix of an eigenvalue of a feature included in the target matrix and the eigenvalue; second evaluation data of the target matrix is generated according to eigenvalue constraint information and the eigenvalue of a feature included in the target matrix; and a sparsity evaluation is performed on the target matrix according to the first evaluation data and the second evaluation data. Due to the fact that the first evaluation data represents a degree of dispersion for the eigenvalues included in the target matrix in terms of distribution, while the second evaluation data represents a degree of approaching zero of the eigenvalue included in the target matrix in terms of numerical; therefore, not only an influence of zero eigenvalues (i.e., the eigenvalue with a value being zero) on a matrix sparsity is considered, but also the influence of non-zero eigenvalues (i.e., the eigenvalue with the value being non-zero) on the matrix sparsity is taken into account, and the degree of dispersion of an overall distribution of respective eigenvalues in the matrix and the overall degree of approaching zero can be accurately measured; thus an effectiveness of the matrix sparsity evaluation is greatly improved. In the field of machine learning, when training data is in a matrix form, the training data in the matrix form can be effectively evaluated based on this effective evaluation method for the matrix sparsity, thereby filtering out the training data that is easy to learn for the machine learning, reducing a learning difficulty for a model, and improving the model performance.

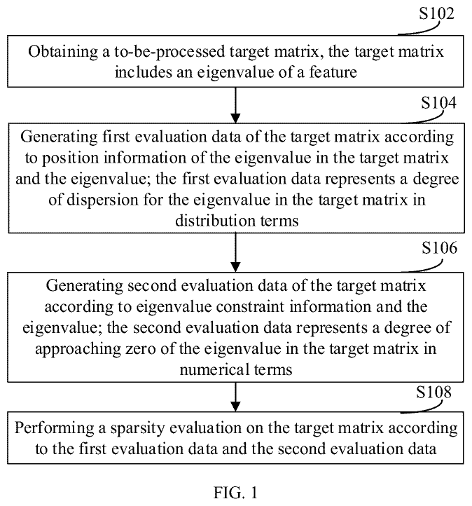

Specifically, FIG. 1 is a flowchart of a data processing method provided by one or more embodiments of the present application. The method in FIG. 1 can be executed by an electronic device, specifically by can be executed by a processor of the electronic device. This electronic device can include a terminal device or a server. Where, the terminal device can be a mobile phone, a tablet, a desktop computer, a portable laptop and the like, and the server can be an independent server, a server cluster consisted of multiple servers, or a cloud server capable of cloud computing. As shown in FIG. 1, the method includes the following steps:
step S102, obtaining a to-be-processed target matrix, the target matrix includes an eigenvalue.

In some embodiments, the electronic device may include an editing module, a user can operate the editing module to edit the target matrix and submit a matrix evaluation request. Correspondingly, the electronic device receives the matrix evaluation request submitted by the user and obtains the to-be-processed target matrix from the matrix evaluation request. In other implementations, the electronic device can communicate and connect with a requesting device, and accordingly, the electronic device can receive the matrix evaluation requests sent by the requesting device, and obtain the to-be-processed target matrix from the matrix evaluation request. In some other implementation, the electronic device can obtain a specified type of target data (such as a viewing record of the user for respective video) from a specified database according to the received matrix evaluation request, generate an initial matrix according to the target data, and perform a dimensionality reduction on the initial matrix to obtain the target matrix. A method for obtaining the target matrix is not specifically limited in the present application, and can be set according to actual needs in practical applications.

In one or more embodiments of the present application, the target matrix may include a target sample matrix, that is, the target matrix includes the eigenvalues of sample features of multiple sample data. Where, the sample data can include voice data, video data, or text data and the like; correspondingly, the sample features can include speech features, video features, or text features and the like. Specifically, in some embodiments, the sample data may include the speech data, and correspondingly, the sample feature includes the speech features; that is to say, the target matrix can include the speech features of multiple speech data; where the speech features can include a playback count, a forwarded count, a commented count and the like of the speech data. In some other implementations, the sample data may include the video data, and correspondingly, the sample feature includes the video feature; that is to say, the target matrix can include the video features of multiple video data; where the video feature can be the playback count, forwarded count, commented count and the like of the video data. In some yet other implementations, the sample data may include the text data, and correspondingly, the sample feature includes the text feature; that is to say, the target matrix can include the text features of multiple text data; where the text feature can include a read count, the forwarded count, the commented count, and a keyword appearing count of the text data.

The target matrix can be in a m*n dimensional, that is, the target matrix includes m rows and n columns, with m*n elements; that is, the target matrix includes m*n eigenvalues, where m*n elements correspond one-to-one to m*n eigenvalues, and m*n eigenvalues correspond one-to-one to m*n features; that is, m*n elements correspond one-to-one to m*n features; both m and n are integers greater than 1. Specific meanings of the features corresponding to the eigenvalues included in the target matrix can be set according to requirements in practical applications. As an example, the target matrix includes the speech features of multiple speech data, each row of the target matrix corresponds to a user, and each column corresponds to one piece of speech data, thus Speech Feature 1 corresponding to Element aᵢⱼ of the target matrix can represent the playback count for the speech data corresponding to the j-th column by the user corresponding to the i-th row; an element value of Element aᵢⱼ is the eigenvalue “playback count” of Speech Feature 1. For example, if Element aᵢⱼ=3, the eigenvalue of Speech Feature 1 is 3, which means that the user corresponding to the i-th row plays the speech data corresponding to column j three times. As another example, the target matrix includes the video features of multiple video data, each row of the target matrix corresponds to one user group, and each column corresponds to one piece of video data, thus Video Feature 1 corresponding to Element aᵢⱼ of the target matrix can represent the forward count for the video data corresponding to the j-th column by the user group corresponding to the i-th row (such as the user group with an age period of 20-25); the element value of Element aᵢⱼ is the eigenvalue “forward count” of Video Feature 1. For example, if Element aᵢⱼ=4, the eigenvalue of Video Feature 1 is 4, which means that the user group corresponding to the i-th row forwards the video data corresponding to the j-th column 4 times. As yet another example, the target matrix includes the text features of multiple text data, each row of the target matrix corresponds to one article, and each column corresponds to one keyword, thus Text Feature 1 corresponding to Element a of the target matrix represents the appearing count of the keyword corresponding to the j-th column in the article corresponding to the i-th row; the element value of Element a is the “appearing count” of the eigenvalue of Text Feature 1. For example, if Element aᵢⱼ=5, the eigenvalue of Text Feature 1 is 5, which means that the keyword corresponding to the j-th column appears 5 times in the article corresponding to the i-th row. Where, 1≤i≤m, 1≤j≤n.

Step S104, generating first evaluation data of the target matrix according to position information of the eigenvalue in the target matrix and the eigenvalue; the first evaluation data represents a degree of dispersion for the eigenvalue in the target matrix in terms of distribution.

Considering that in the existing methods for determining a matrix sparsity, an influence of the distribution of non-zero elements on the matrix sparsity has been ignored, thus an accuracy of data processing is relatively low. Based on this, in the embodiment of the present application, the first evaluation data, which is used to represent the degree of dispersion of respective eigenvalues in the target matrix in terms of distribution, is generated according to the position information of respective eigenvalues in the target matrix and respective eigenvalues, the respective eigenvalues included in the target matrix. Where, the higher the degree of dispersion, representing the smaller the sparsity of the target matrix; on the contrary, the lower the degree of dispersion, representing the greater the sparsity of the target matrix.

It should be pointed out that, since each element in the target matrix corresponds to one eigenvalue, it can be understood that for the target matrix in the m*n dimension, it is obtained by arranging and combining m*n eigenvalues. For different arrangement and combination modes of m*n eigenvalues, positions of the eigenvalues in the target matrix vary. The position of the eigenvalue in the target matrix reflects the distribution of eigenvalues in the target matrix. Therefore, the first evaluation data can represent the degree of dispersion of the eigenvalues in terms of distribution. Furthermore, since the element value for each element in the target matrix corresponds to one eigenvalue, and respective eigenvalues corresponds to one feature, the first detection data can also represent a complexity of multiple features in terms of distribution.

Step S106, generating second evaluation data of the target matrix according to eigenvalue constraint information and the eigenvalue; the second evaluation data represents a degree of approaching zero for the eigenvalue in the target matrix in terms of numerical.

Considering that in the existing methods for determining the matrix sparsity, a proportion of zero-value elements is only considered, without taking into account an overall zero tendency of the matrix or an impact of extremely values on the matrix sparsity, thus the accuracy of determining the matrix sparsity is relatively low. Based on this, in the embodiment of the present application, the eigenvalue constraint information is set to eliminate the influence of the extremely values on the matrix sparsity. And the second evaluation data, which is used to represent the degree of approaching zero of respective eigenvalues in the target matrix in terms of numerical, is generated according to the eigenvalue constraint information and the respective eigenvalues included in the target matrix. Where, the greater the degree of approaching zero, representing the more eigenvalues tend to zero; on the contrary, the smaller the degree of approaching zero, representing the more eigenvalues deviate from zero.

Step S108, performing a sparsity evaluation on the target matrix according to the first evaluation data and the second evaluation data.

In one or more embodiments of the present application, when the to-be-processed target matrix is obtained, the first evaluation data of the target matrix is generated according to the position information of the eigenvalue in the target matrix and the eigenvalue, the eigenvalue included in the target matrix; the second evaluation data of the target matrix is generated according to the eigenvalue constraint information and the eigenvalue included in the target matrix; and the sparsity evaluation is performed on the target matrix according to the first evaluation data and the second evaluation data. Due to the fact that the first evaluation data represents the degree of dispersion for the eigenvalue included in the target matrix in terms of distribution, while the second evaluation data represents the degree of approaching zero of the eigenvalue included in the target matrix in terms of numerical; therefore, not only an influence of zero eigenvalues (i.e., the eigenvalue with a value being zero) on the matrix sparsity is considered, but also the influence of non-zero eigenvalues (i.e., the eigenvalue with the value being non-zero) on the matrix sparsity is taken into account, and the degree of dispersion of an overall distribution of respective eigenvalues in the matrix and the overall degree of approaching zero can be accurately measured; thus an effectiveness of the matrix sparsity evaluation is greatly improved. In the field of machine learning, when training data is in a matrix form, the training data in the matrix form can be effectively evaluated based on this effective evaluation method for the matrix sparsity, thereby filtering out the training data that is easy to learn for the machine learning, reducing a learning difficulty for a model, and improving model performance.

In order to accurately measure a degree of dispersion for multiple eigenvalues included in a target matrix in terms of distribution, in one or more embodiments of the present application, first evaluation data is generated according to eigenvalue fluctuation information of an eigenvalue combination corresponding to respective target vectors.

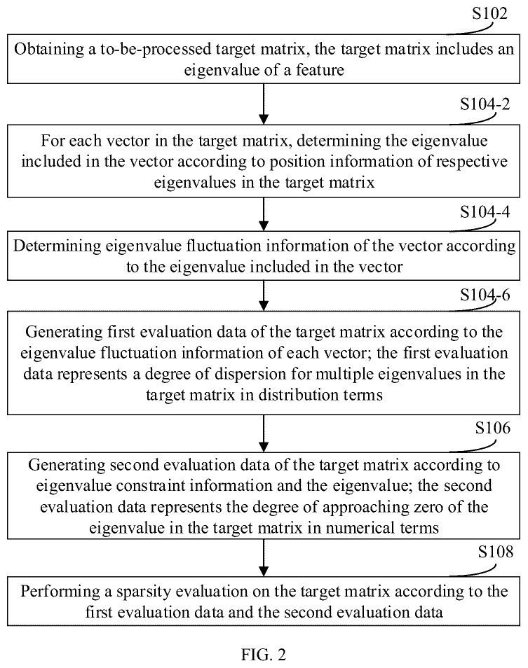

Specifically, as shown in FIG. 2, step S104 can include the following steps S104-2 to S104-6:
step S104-2, for each vector in the target matrix, determining the eigenvalue included in the vector according to position information of respective eigenvalues in the target matrix.

In some implementations, each vector in the target matrix can be a row vector, and correspondingly, the position information can be a row number. In other implementations, each vector in the target matrix can be a column vector, and correspondingly, the position information can be a column number. Specifically, when each vector in the target matrix is the row vector, the eigenvalue included in each vector in the target matrix can be determined according to the row number of respective eigenvalues in the multiple eigenvalues included in the target matrix; that is, for each vector in the target matrix, the row number of respective eigenvalues is matched with the row number corresponding to the vector, and the eigenvalue corresponding to the row number that successfully matched is determined as the eigenvalue included in the vector. When each vector in the target matrix is the column vector, the eigenvalue included in each vector in the target matrix can be determined according to the column number of respective eigenvalues in the multiple eigenvalues included in the target matrix; that is, for each vector in the target matrix, the column number of respective eigenvalues is matched with the column number corresponding to the vector, and the eigenvalue corresponding to the column number that successfully matched is determined as the eigenvalue included in the vector. In the following text, the vectors being the row vectors are taken as example for description. When the vector is the column vector, the relevant description of one-way vector being the row vector can be referred to, and the rows can be replaced with columns in the relevant description.

As an example, the target matrix is

$$[ \begin{matrix}0 & 5 & 6 \\ 7 & 0 & 0\end{matrix} ]$$

and the vector is the row vector, then the target matrix consists of two vectors, denoted as Vector 1 and Vector 2 in a from-top-to-bottom order. The row numbers of eigenvalues 0, 5 and 6 are all 1, which matches the row number corresponding to Vector 1. Therefore, it is determined that the eigenvalues included in Vector 1 are 0, 5, and 6; that is, the eigenvalues included in Vector 1 are eigenvalues in the first row; the row numbers of eigenvalues 7, 0 and 0 are all 2, which matches the row number corresponding to Vector 2. Therefore, it is determined that the eigenvalues included in Vector 2 are 7, 0 and 0; that is, the eigenvalues included in Vector 2 are eigenvalues in the second row. Similarly, when the vector is the column vector, the target matrix includes Vector 1, Vector 2, and Vector 3 in a from-left-to-right order; the eigenvalues included in Vector 1 are eigenvalues 0 and 7 in the first column, the eigenvalues included in Vector 2 are eigenvalues 5 and 0 in the second column, and the eigenvalues included in Vector 3 are eigenvalues 6 and 0 in the third column.

Step S104-4, determining eigenvalue fluctuation information of the vector according to the eigenvalue included in the vector;

Specifically, for each vector in each target matrix, a first amount of non-zero eigenvalues in the eigenvalues included in the vector is determined; a deduplication processing is performed on the non-zero eigenvalues corresponding to the vector to obtain a second amount of remaining non-zero eigenvalues; and the maximum and minimum eigenvalues among the eigenvalues included in the vector are identified; and the first amount, second amount, maximum eigenvalue and minimum eigenvalue are determined as the eigenvalue fluctuation information of the vector.

As an example, the vector is the row vector, and the certain vector includes 9 eigenvalues, namely 1, 0, 3, 2, 1, 0, 1, 0, 1 in the from-left-to-right order. It can be determined that the non-zero eigenvalues included in the vector are 1, 3, 2, 1, 1 and 1, that is, the first amount is 6; the remaining non-zero eigenvalues are 1, 3, and 2 after performing the deduplication processing on the non-zero eigenvalues, that is, the second amount is 3; the maximum eigenvalue included in this vector is 3, and the minimum eigenvalue is 0. The first amount 6, second amount 3, maximum eigenvalue 3 and minimum eigenvalue 0 are determined as the eigenvalue fluctuation information of this vector.

Step S104-6, generating the first evaluation data of the target matrix according to the eigenvalue fluctuation information of each vector; the first evaluation data represents a degree of dispersion for multiple eigenvalues in the target matrix in terms of distribution.

In order to accurately generate the first evaluation data, in the embodiment of the present application, an eigenvalue dispersion degree of each vector is determined according to the eigenvalue fluctuation information of each vector; and the first evaluation data of the target matrix is generated based on the eigenvalue dispersion degree of each vector and the number of vectors included in the target matrix. Specifically, for each vector in the target matrix, eigenvalue distribution information of the vector is determined based on the first and second amounts in the eigenvalue fluctuation information of the vector; an eigenvalue fluctuation range of the vector is determined according to the maximum and minimum eigenvalues in the eigenvalue fluctuation information of the vector; the eigenvalue divergence of the vector is determined based on the eigenvalue distribution information and the eigenvalue fluctuation range; and the first evaluation data of the target matrix is generated according to the eigenvalue dispersion of each vector and the number of vectors included in the target matrix. Where, the eigenvalue dispersion of the vector represents the degree of dispersion of the eigenvalues included in the vector in terms of distribution.

More specifically, for the eigenvalue fluctuation information of each vector, the first amount and the second amount in the eigenvalue fluctuation information of the vector are added to obtain the eigenvalue distribution information of the vector; the maximum eigenvalue and the minimum eigenvalue in the eigenvalue fluctuation information of the vector are subtracted to obtain the eigenvalue fluctuation range of the vector; the eigenvalue distribution information of the vector is divided by the eigenvalue fluctuation range to obtain the eigenvalue divergence of the vector; an average value of the eigenvalue dispersion of each vector in the target matrix is determined, and this average value is determined as the first evaluation data of the target matrix.

In some implementations, the first evaluation data is denoted as ω, then:

$$ω = \frac{1}{m} * {\sum }_{i = 1}^{m} \frac{{a}_{i} + {b}_{i}}{{max}_{i} - {min}_{i}} .$$

Using the vector being the row vector for explanation, where aᵢ represents the first amount of non-zero eigenvalues in the eigenvalues included in the i-th vector (i.e., the i-th row) is denoted as a; bᵢ represents the second amount of remaining non-zero eigenvalues after the deduplication process is performed on the non-zero eigenvalue of the i-th vector is denoted as b; maxᵢ represents the maximum eigenvalue included in the i-th vector, and minᵢ represents the minimum eigenvalue included in the eigenvalues included in the i-th vector; aᵢ+bᵢ represents the eigenvalue distribution information of the i-th vector; maxᵢ−minᵢ represents the eigenvalue fluctuation range of the i-th vector;

$$\frac{{a}_{i} + {b}_{i}}{{max}_{i} - {min}_{i}}$$

represents the eigenvalue dispersion degree of the i-th vector, that is, the degree of dispersion of the eigenvalues within a unit fluctuation range; m is the number of vectors included in the target matrix (i.e., a total row amount in the target matrix); ω represents the average value of eigenvalue dispersion degree of each vector, which is the first evaluation data; the larger the ω, the more non-zero eigenvalues in multiple eigenvalues included in the target matrix, and the larger the second amount corresponding to these non-zero eigenvalues; that is, the degree of dispersion of the multiple eigenvalues included in the target matrix in the in terms of distribution is higher, and the sparsity of the target matrix is smaller.

It can be seen that, when generating the first evaluation data, it is performed based on the position information of respective eigenvalues included in the target matrix and respective eigenvalues, which involves both zero eigenvalues (i.e., the eigenvalue with a value being zero) and non-zero eigenvalues (i.e., the eigenvalue with the value being non-zero). Therefore, the sparsity of the target matrix is evaluated from a perspective of an overall distribution of respective eigenvalues in the target matrix, rather than solely based on zero eigenvalues, thereby greatly improving an accuracy of the sparsity evaluation.

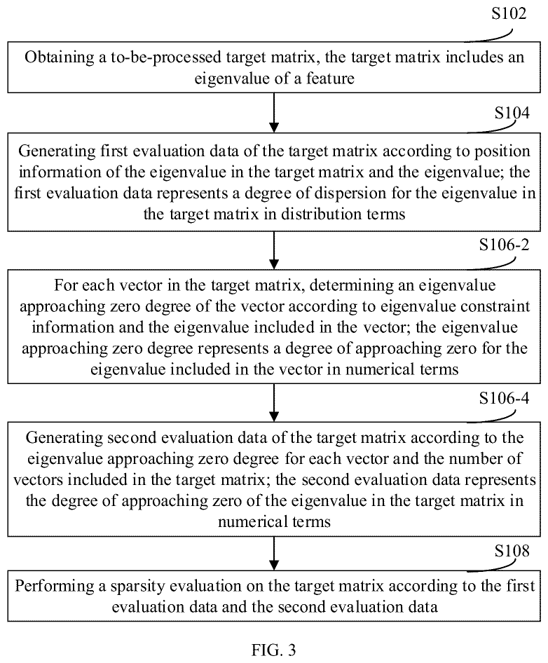

While evaluating a sparsity of a target matrix from a perspective of an overall distribution, the present application also evaluates the sparsity of the target matrix from an overall zero convergence for the target matrix in terms of numerical. Specifically, as shown in FIG. 3, step S106 can include the following steps S106-2 and S106-4:
step S106-2, for each vector in the target matrix, determining an eigenvalue approaching zero degree for the vector according to eigenvalue constraint information and the eigenvalue included in the vector; the eigenvalue approaching zero degree represents the degree of approaching zero of the eigenvalue included in the vector in terms of numerical;
specifically, for each vector in the target matrix, an eigenvalue average and a median of the vector are determined according to the respective eigenvalues included in the vector; a target eigenvalue is selected from the eigenvalues included in the vector according to the eigenvalue constraint information, a size relationship between the eigenvalue average and the median; and the eigenvalue approaching zero degree of the vector is determined according to the target eigenvalue and the number of target eigenvalue.

More specifically, for each vector in the target matrix, the eigenvalue average of the respective eigenvalues included in the vector is determined; the respective eigenvalues included in the vector are sorted in an ascending order, the median of the vector is determined according to a sorting result; the size relationship between the eigenvalue average and the median of the vector is determined. When the eigenvalue average is greater than the median, for respective eigenvalues included in the vector, it is determined whether the eigenvalue is the maximum eigenvalue among the eigenvalues included in the vector according to the eigenvalue constraint information, if it is the maximum eigenvalue, this eigenvalue will be discarded; if it is not the maximum eigenvalue, this eigenvalue will be determined as the target eigenvalue; and an average of the target eigenvalues is determined according to the target eigenvalues and the number of target eigenvalues, and the average is determined as the eigenvalue approaching zero degree of the vector. When the eigenvalue average is less than the median, for respective eigenvalues included in the vector, it is determined whether the eigenvalue is the minimum eigenvalue among the eigenvalues included in the vector according to the eigenvalue constraint information, if it is the minimum eigenvalue, this eigenvalue will be discarded; if it is not the minimum eigenvalue, this eigenvalue will be determined as the target eigenvalue; the average of the target eigenvalues is determined according to the target eigenvalue and the number of target eigenvalues, and this average will be determined as the eigenvalue approaching zero degree of the vector. When the eigenvalue average is equal to the median, an absolute value for respective eigenvalues included in the vector is taken according to the eigenvalue constraint information, and the absolute value is determined as the target eigenvalue; and the average of the target eigenvalues is determined according to the target eigenvalue and the number of target eigenvalues, and this average will be determined as the eigenvalue approaching zero degree of the vector.

Where, the median is used to measure a concentrated trend for a set of data (in the present application, for measuring a set of eigenvalues), which represents the median of a dataset, that is, the data in a middle position after sorting the data from small to large. When the number of data in the dataset is odd, the data in the middle position of the sorting result is the median of this set of data; and when the number of data is even, the average of two data in the middle position of the sorting result is the median of this set of data.

Step S106-4, generating second evaluation data of the target matrix according to the eigenvalue approaching zero degree for each vector and the number of vectors included in the target matrix; the second evaluation data represents the degree of approaching zero of the eigenvalue in the target matrix in terms of numerical.

Specifically, an average of the eigenvalue approaching zero degree is determined according to the eigenvalue approaching zero degree for each vector and the number of vectors included in the target matrix, and the average of the eigenvalue approaching zero degree is determined as the second evaluation data of the target matrix.

In some implementations, the second evaluation data is denoted as γ, and the vector being a row vector is used for explanation, it will have the following Formulas 1 to 4:

$$γ = \frac{1}{m} * {\sum }_{i = 1}^{m} {τ}_{i} ; \qquad Formula 1$$

$${τ}_{i} = \{ \begin{matrix}\frac{1}{n - 1} * {\sum {I}_{1} ,}_{j = 1}^{n} & when {α}_{i} < {β}_{i} \\ \frac{1}{n - 1} * {\sum }_{j = 1}^{n} {I}_{2} , & when {α}_{i} > {β}_{i} \\ \frac{1}{n} * {\sum }_{j = 1}^{n} \vert {x}_{i , j} \vert , & when {α}_{i} = {β}_{i}\end{matrix} \qquad Formula 2$$

$${I}_{1} = \{ \begin{matrix}{x}_{i , j} , & when {x}_{i , j} \neq {max}_{i} \\ 0 , & when {x}_{i , j} = {max}_{i}\end{matrix} \qquad Formula 3$$

$${I}_{2} = \{ \begin{matrix}{x}_{i , j} , & when {x}_{i , j} \neq {min}_{i} \\ 0 , & when {x}_{i , j} = {min}_{i}\end{matrix} \qquad Formula 4$$

where, τᵢ represents the eigenvalue approaching zero degree of the i-th vector; αᵢ represents the median of the i-th vector; βᵢ represents the eigenvalue average of the i-th vector; I₁ and I₂ represent the eigenvalue constraint information; maxᵢ represents the maximum eigenvalue among the eigenvalues included in the i-th vector; minᵢ represents the minimum eigenvalue among the eigenvalues included in the i-th vector; x_{i,j} represents the j-th eigenvalue among the eigenvalues included in the i-th vector (i.e. an element value corresponding to an element in the i-th row and j-th column); 0 represents a discarding eigenvalue; |x_{i,j}| represents taking the absolute value of the j-th eigenvalue included in the i-th vector; n is a total column amount in the target matrix; m is the number of vectors included in the target matrix (i.e., a total row amount in the target matrix).

It can be seen that, in a generation process of the second evaluation data, it is performed according to respective eigenvalues included in the target matrix, which involves both zero eigenvalues (i.e., the eigenvalue being zero) and non-zero eigenvalues (i.e., the eigenvalue being non-zero). Therefore, the sparsity of the target matrix is evaluated based on an overall value for respective eigenvalues in the target matrix, rather than evaluating the sparsity of the target matrix solely based on the zero eigenvalue, thereby greatly improving an accuracy of a sparsity evaluation. Furthermore, due to an agreement in the eigenvalue constraint information that the maximum eigenvalue is discarded when the eigenvalue average is greater than the median; and the agreement that the minimum eigenvalue is discarded when the eigenvalue average is less than the median; thus an impact of extreme values (deviating from a normal value) on a matrix sparsity can be effectively avoided, which further improves the accuracy of the sparsity evaluation.

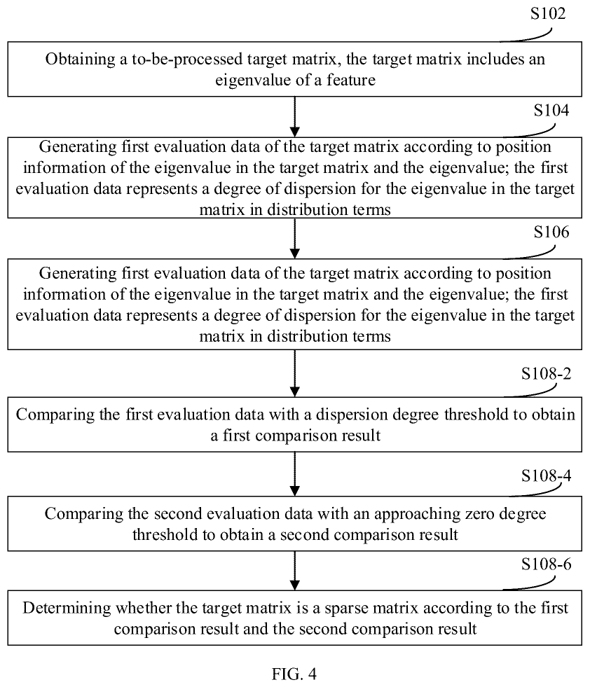

After generating first and second evaluation data, it may evaluate whether a target matrix is a sparse matrix according to the first evaluation data and the second evaluation data. Specifically, as shown in FIG. 4, step S108 may include steps S108-2 to S108-6 as follows:
step S108-2, comparing the first evaluation data with a dispersion degree threshold to obtain a first comparison result;
step S108-4, comparing the second evaluation data with an approaching zero degree threshold to obtain a second comparison result;
step S108-6, determining whether the target matrix is the sparse matrix according to the first comparison result and the second comparison result.

Specifically, when the first comparison result represents that the first evaluation data is greater than the dispersion degree threshold, and the second comparison result represents that the second evaluation data is greater than the approaching zero degree threshold, it is determined that the target matrix is not the sparsity matrix; otherwise, it is determined that the target matrix is the sparsity matrix. Where, the dispersion degree threshold and the approaching zero degree threshold can be: after respective training data in a matrix form is pre-evaluated based on the above method, and the first and second evaluation data for each training data is obtained, a model training process is performed according to the training data, and a corresponding first evaluation data when obtaining a target model is determined as the dispersion degree threshold, and a corresponding second evaluation data when obtaining the target model is determined as the approaching zero degree threshold.

Therefore, by combining an overall distribution situation of respective eigenvalues and an overall approaching zero situation of respective eigenvalues in the target matrix, the sparsity of the target matrix is jointly evaluated, which improves an accuracy of an evaluation result, and achieving an effective evaluation for the matrix sparsity.

As mentioned earlier, the target matrix includes a target sample matrix. Therefore, in one or more embodiments of the present application, after step S108, the following step S110 may also be included:
step S110, if the evaluation result represents that the target matrix is not the sparse matrix, then performing an iteratively training on a to-be-trained network using the target matrix.

Specifically, if the evaluation result represents that the target matrix is not the sparse matrix, the target matrix is determined as target training data, and the target training data is used to iteratively train the to-be-trained network to obtain the target model.

In some implementations, the target model is an article recommendation model. In the Internet era, a large number of articles are produced every day. How to distinguish these articles and then accurately recommend them to interested users is usually: setting up different keyword banks for different fields, and recommending according to a frequency of these keywords in the article. Due to the keyword banks in different fields are different, there will be thousands of independent words in keyword banks in multiple fields, and each article can only hit a very small number of keywords, thus resulting training data is the sparse matrix. If the sparse matrix is used for model training at this time, it will inevitably increase a learning difficulty of a model, then a quality article recommendation model cannot be obtained, thereby impacting a recommendation effect for the user. Therefore, the sparse matrix can be determined as an initial matrix, and operations such as a dimensionality reduction can be performed on the initial matrix to obtain a to-be-processed target matrix. That is to say, the target matrix includes the eigenvalues of text features from multiple text data, where the text data includes the keywords and articles, the text feature includes the appearing counts of keywords in the article, and the eigenvalue is the appearing count. For example, the keyword bank includes 30000 different words, by selecting 1000 articles, each row corresponds to one article, and each column corresponds to one keyword, the initial matrix of 1000*30000 can be formed. The text feature corresponding to each element in the initial matrix is the appearing count of the corresponding keyword in the corresponding article; for example, if data in the third row and fifth column is 2, it means that the appearing count of the fifth word appears in the third article is 2. Due to the fact that the length of most articles is relatively short, which can only include partial words of 30000 words, thus most data in each row is zero, and the initial matrix is the sparse matrix at this time. The target matrix can be obtained by performing operations such as the dimensionality reduction on the initial matrix; for example, the initial matrix of 1000*30000 is dimensionally reduced to obtain the target matrix of 500*300. At this point, the first evaluation data of the target matrix can be generated according to position information of the eigenvalue of the text feature in the target matrix and the eigenvalue of the text features based on the above data processing method; the second evaluation data of the target matrix can be generated according to eigenvalue constraint information and the eigenvalues of the text feature in the target matrix, then the first evaluation data is compared with first preset data to obtain the first comparison result; the second evaluation data is compared with second preset data to obtain the second comparison result; the target matrix is determined as not the sparse matrix when the first comparison result represents that the first evaluation data is greater than the first preset data, and the second comparison result represents that the second evaluation data is greater than the second preset data, and the target matrix is determined as a target training sample. Based on the above method, multiple target training samples can be obtained, and the to-be-trained network can be trained using the target training samples, so as to obtain the article recommended model.

It should be noted that, the data processing method provided in the embodiment of the present application is not limited to being applied to the training process of the above article recommended model; as long as the training data of the model is in the matrix form, it can be applied, and this will not be listed and explained one by one in the present application. Therefore, before performing a training processing, a sparsity evaluation is first performed on the respective training data in the matrix form, and the training processing is based on the target training data that is not the sparse matrix, which ensuring features in the target training data have a separability, thereby greatly reducing the learning difficulty of the model and improving model performance.

Furthermore, considering that there may be a large number of training samples in a machine learning process, it is often necessary to compare the sparsity between these large number of training samples in order to obtain the target training samples. Based on this, in one or more embodiments of the present application, the following steps S112 and S114 may be further included after step S108:
step S112, determining a sparsity parameter of the target matrix according to the first evaluation data and the second evaluation data;
specifically, the sparsity parameter is denoted as θ, then

$$θ = \frac{2 * ω * γ}{ω + γ} ;$$

where, ω represents the first evaluation data, and γ represents the second evaluation data.

Step S114, performing a sparsity comparison on the target matrix and a to-be-compared matrix according to the sparsity parameter.

Specifically, for respective to-be-compared matrix, the sparsity parameter of the to-be-compared matrix is determined; and the comparison process is performed between the sparsity parameters of the target matrix with the sparsity parameter of the to-be-compared matrix. When a comparison result represents that the sparsity parameter of the target matrix is greater than that of the to-be-compared matrix, which represents that the sparsity of the target matrix is smaller than that of the to-be-compared matrix; when the comparison result represents that the sparsity parameter of the target matrix is smaller than that of the to-be-compared matrix, which represents that the sparsity of the target matrix is greater than that of the to-be-compared matrix. Therefore, based on the first evaluation data and the second evaluation data, a sparsity comparison between different matrices can be achieved.

In one or more embodiments of the present application, when the to-be-processed target matrix is obtained, the first evaluation data of the target matrix is generated according to the position information of multiple features in the target matrix and the eigenvalue of the multiple features, the multiple features included in the target matrix; the second evaluation data of the target matrix is generated according to the eigenvalue constraint information and the eigenvalue of the multiple features included in the target matrix; and the sparsity evaluation is performed on the target matrix according to the first evaluation data and the second evaluation data. Due to the fact that the first evaluation data represents the degree of dispersion of the multiple features included in the target matrix in terms of distribution, while the second evaluation data represents the degree of approaching zero of the multiple features included in the target matrix in terms of numerical; therefore, not only an influence of feature whose eigenvalue is zero on the matrix sparsity is considered, but also the influence of feature whose eigenvalue is non-zero on the matrix sparsity is taken into account, and the degree of dispersion of an overall distribution of respective features in the matrix and the overall degree of approaching zero can be accurately measured; thus an effectiveness of the matrix sparsity evaluation is greatly improved. In the field of machine learning, the training data in the matrix form can be effectively evaluated, and the effective training data is provided for machine learning, thereby reducing a learning difficulty for a model, and improving the model performance.

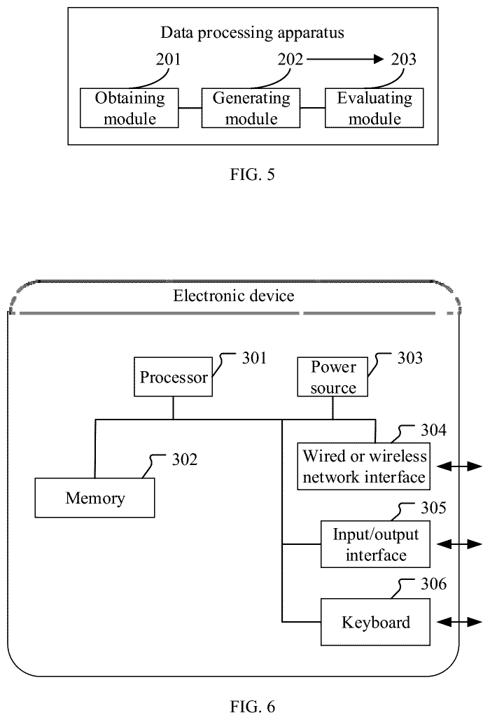

Corresponding to the data processing method described above, based on the same technical concept, one or more embodiments of the present application also provide a data processing apparatus. FIG. 5 is a module composition diagram of the data processing apparatus provided by one or more embodiments of the present application. As shown in FIG. 5, the apparatus includes:
an obtaining module 201, configured to obtain a to-be-processed target matrix; the target matrix includes an eigenvalue corresponding to a feature;
a generating module 202, configured to generate first evaluation data of the target matrix according to position information of the eigenvalue in the target matrix and the eigenvalue, the first evaluation data represents a degree of dispersion for the eigenvalue in terms of distribution;
the generation module 202 is further configured to second evaluation data of the target matrix according to eigenvalue constraint information and the eigenvalue, the second evaluation data represents a degree of approaching zero for the eigenvalue in terms of numerical;
an evaluating module 203, configured to perform a sparsity evaluation on the target matrix according to the first evaluation data and the second evaluation data.

Based on the data processing apparatus provided by the embodiment of the present application, when the to-be-processed target matrix is obtained, the first evaluation data of the target matrix is generated according to the position information of the eigenvalue in the target matrix and the eigenvalue, the eigenvalue included in the target matrix; the second evaluation data of the target matrix is generated according to the eigenvalue constraint information and the eigenvalue included in the target matrix; and a sparsity evaluation is performed on the target matrix according to the first evaluation data and the second evaluation data. Due to the fact that the first evaluation data represents the degree of dispersion of the eigenvalue included in the target matrix in terms of distribution, while the second evaluation data represents the degree of approaching zero of the eigenvalue included in the target matrix in terms of numerical; therefore, not only an influence of zero eigenvalues (i.e., the eigenvalue with a value being zero) on the matrix sparsity is considered, but also the influence of non-zero eigenvalues (i.e., the eigenvalue with the value being non-zero) on the matrix sparsity is taken into account, and the degree of dispersion of an overall distribution of respective eigenvalues in the matrix and the overall degree of approaching zero can be accurately measured; thus an effectiveness of the matrix sparsity evaluation is greatly improved. In the field of machine learning, when training data is in a matrix form, the training data in the matrix form can be effectively evaluated based on this effective evaluation method for the matrix sparsity, thereby filtering out the training data that is easy to learn for the machine learning, reducing a learning difficulty for a model, and improving model performance.

It should be noted that, the embodiment related to the data processing apparatus in the present application and the embodiment related to the data processing method in the present application are based on the same invention concept. Therefore, a specific implementation of this embodiment can refer to the implementation of the corresponding data processing method mentioned above, and any repetition will not be elaborate.

Respective module in the above data processing apparatus can be fully or partially implemented through software, hardware, and their combinations. The above respective module can be embedded in a hardware form or independent of a processor in a terminal device or a processor on a server, or can be stored in a software form in a memory of the terminal device or a memory of the server, so that the processor can expediently call to execute operations corresponding the above respective module.

Furthermore, corresponding to the data processing method described above, based on the same technical concept, one or more embodiments of the present application also provide an electronic device, and the electronic device is configured to execute the above data processing method. FIG. 6 is a structural diagram of the electronic device provided by one or more embodiments of the present application.

As shown in FIG. 6, the electronic device may vary significantly due to differences in configurations or performance, and may include one or more processors 301 and a memory 302, where the memory 302 may store one or more stored applications or data. Where, the memory 302 can be a temporary storage or a persistent storage. The application stored in the memory 302 may include one or more modules (not shown in the figures), each module may include a series of computer-executable instructions in the electronic device. Furthermore, the processor 301 can be configured to communicate with the memory 302, and the series of computer-executable instructions in memory 302 can be executed on the electronic device. The electronic device may also include one or more power sources 303, one or more wired or wireless network interfaces 304, one or more input/output interfaces 305, one or more keyboards 306 and the like.

In a specific embodiment, the electronic device includes a memory and one or more programs, where one or more programs are stored in the memory, one or more programs may include one or more modules, and each module may include the series of computer-executable instructions in the electronic device, and is configured to be executed by one or more processors, the one or more programs may include computer-executable instructions for performing the following:
obtaining a to-be-processed target matrix, the target matrix includes an eigenvalue corresponding to a feature;
generating first evaluation data of the target matrix according to position information of the eigenvalue in the target matrix and the eigenvalues, the first evaluation data represents a degree of dispersion for the eigenvalue in terms of distribution;
generating second evaluation data of the target matrix according to eigenvalue constraint information and the eigenvalue, the second evaluation data represents a degree of approaching zero for the eigenvalue in terms of numerical;
performing a sparsity evaluation on the target matrix according to the first evaluation data and the second evaluation data.

Based on the electronic device provided in one or more embodiments of the present application, when the to-be-processed target matrix is obtained, the first evaluation data of the target matrix is generated according to the position information of the eigenvalue in the target matrix and the eigenvalue, the eigenvalue included in the target matrix; the second evaluation data of the target matrix is generated according to the eigenvalue constraint information and the eigenvalue included in the target matrix; and a sparsity evaluation is performed on the target matrix according to the first evaluation data and the second evaluation data. Due to the fact that the first evaluation data represents the degree of dispersion of the eigenvalue included in the target matrix in terms of distribution, while the second evaluation data represents the degree of approaching zero of the eigenvalue included in the target matrix in terms of numerical; therefore, not only an influence of zero eigenvalues (i.e., the eigenvalue with a value being zero) on the matrix sparsity is considered, but also the influence of non-zero eigenvalues (i.e., the eigenvalue with the value being non-zero) on the matrix sparsity is taken into account, and the degree of dispersion of an overall distribution of respective eigenvalues in the matrix and the overall degree of approaching zero can be accurately measured; thus an effectiveness of the matrix sparsity evaluation is greatly improved. In the field of machine learning, when training data is in a matrix form, the training data in the matrix form can be effectively evaluated based on this effective evaluation method for the matrix sparsity, thereby filtering out the training data that is easy to learn for the machine learning, reducing a learning difficulty for a model, and improving model performance.

It should be noted that, the embodiment related to the electronic device in the present application and the embodiment related to the data processing method in the present application are based on the same invention concept. Therefore, a specific implementation of this embodiment can be referred to the implementation of the corresponding data processing method mentioned above, and any repetition will not be elaborate.

Furthermore, corresponding to the data processing method described above, based on the same technical concept, one or more embodiments of the present application also provide a storage medium for storing computer-executable instructions. In a specific embodiment, the storage medium can be a USB drive, an optical disc, a hard disk and the like. When the computer-executable instructions stored in the storage medium are executed a processor, the following process can be achieved:
obtaining a to-be-processed target matrix, the target matrix includes an eigenvalue corresponding to a feature;
generating first evaluation data of the target matrix according to position information of the eigenvalue in the target matrix and the eigenvalues, the first evaluation data represents a degree of dispersion for the eigenvalue in terms of distribution;
generating second evaluation data of the target matrix according to eigenvalue constraint information and the eigenvalue, the second evaluation data represents a degree of approaching zero for the eigenvalue in terms of numerical;
performing a sparsity evaluation on the target matrix according to the first evaluation data and the second evaluation data.

When the computer-executable instructions stored in the storage medium provided by one or more embodiments of the present application are executed by the processor, and when the to-be-processed target matrix is obtained, the first evaluation data of the target matrix is generated according to the position information of the eigenvalue in the target matrix and the eigenvalue, the eigenvalue included in the target matrix; the second evaluation data of the target matrix is generated according to the eigenvalue constraint information and the eigenvalue included in the target matrix; and a sparsity evaluation is performed on the target matrix according to the first evaluation data and the second evaluation data. Due to the fact that the first evaluation data represents the degree of dispersion of the eigenvalue included in the target matrix in terms of distribution, while the second evaluation data represents the degree of approaching zero of the eigenvalue included in the target matrix in terms of numerical; therefore, not only an influence of zero eigenvalues (i.e., the eigenvalue with a value being zero) on the matrix sparsity is considered, but also the influence of non-zero eigenvalues (i.e., the eigenvalue with the value being non-zero) on the matrix sparsity is taken into account, and the degree of dispersion of an overall distribution of respective eigenvalues in the matrix and the overall degree of approaching zero can be accurately measured; thus an effectiveness of the matrix sparsity evaluation is greatly improved. In the field of machine learning, when training data is in a matrix form, the training data in the matrix form can be effectively evaluated based on this effective evaluation method for the matrix sparsity, thereby filtering out the training data that is easy to learn for the machine learning, reducing a learning difficulty for a model, and improving model performance.

It should be noted that, the embodiments related to the storage medium in the present application and the embodiments related to the data processing method and in the present application are based on the same invention concept. Therefore, a specific implementation of this embodiment can be referred to the implementation of the corresponding data processing method and mentioned above, and any repetition will not be elaborate.

The above describes specific embodiments of the present application, and other embodiments are within a scope of the attached claims. In some cases, actions or steps recorded in the claims may be executed in a different order than that in the embodiments, and still can achieve a desired result. In addition, a process depicted in accompanying drawings does not necessarily require the shown specific order or continuous order to achieve the desired result. In some implementations, multitasking processing and parallel processing are also possible or may be advantageous.

In the 1990s, there was a clear distinction between hardware improvements (such as an improvement in circuit structures such as diodes, transistors, switches and the like) and software improvements (such as the improvement in method flows) for one technological improvement. However, with a development of technology, many current improvements in the method flow can now be considered as the direct improvement in hardware circuit structures. Designers almost always obtain the corresponding hardware circuit structure by programming the improved method flow into the hardware circuit. Therefore, it cannot be considered that the improvement of the method flow cannot be achieved through hardware entity modules. For example, a programmable logic device (PLD) (such as a field programmable gate array (FPGA)) is an integrated circuit, in which a logic function is determined by the user programming the device. The designer can program and integrate a digital system onto a single PLD without having to hire a chip manufacturer to design and manufacture specialized integrated circuit chips. Moreover, nowadays, replacing a manual production of the integrated circuit chip, this kind of programming is mostly implemented using “logic compiler” software, which is similar to the software compiler used in a program development and writing. An original code before compilation also needs to be written in a specific programming language, which is called a hardware description language (HDL). The HDL not only has one type, but also has many types, such as Advanced Boolean Expression Language (ABEL), Altera Hardware Description Language (AHDL), Confluence, Cornell University Programming Language (CUPL), HDCal, JJava Hardware Description Language (JHDL) Lava, Lola, MyHDL, PALASM, Ruby Hardware Description Language (RHDL) and the like, and currently, the most commonly used are Very-High-Speed Integrated Circuit Hardware Description Language (VHDL) and Verilog. Those skilled in the art should also be aware that, simply by logically programming the method flow using the above hardware description languages and programming it into the integrated circuit, the hardware circuit that implements this logic method flow can be easily obtained.

A controller can be implemented in any appropriate way, for example, the controller can take the form of a microprocessor or a processor, a computer-readable medium that stores computer-readable program codes (such as software or firmware) that can be executed by the (micro) processor, a logic gate, a switch, an application specific integrated circuit (ASIC), a programmable logic controller, and an embedded microcontroller. Examples of the controller include but are not limited to the following microcontrollers: ARC 625D, Atmel AT91SAM, Microchip PIC18F26K20, and Silicon Labs C8051F320. A memory controller can also be implemented as a part of the control logic of the memory. Those skilled in the art also know that, in addition to implementing the controller in purely computer-readable program codes, it is entirely possible to logically program method steps to enable the processor to achieve the same functionality through in the form of logic gates, switches, dedicated integrated circuits, programmable logic controllers, and embedded microcontrollers. Therefore, this type of controller can be considered as a hardware component, and an included apparatus which is used to achieve various functions can also be considered as structures within the hardware component. Alternatively, the apparatus used to implement various functions can be considered as both the software module for implementations and the structure within the hardware component.

The system, apparatus, module or unit described in the above embodiments can be specifically implemented by computer chips or entities, or by products with certain functions. A typical implementation device is a computer. Specifically, the computer can be a personal computer, a laptop, a cellular phone, a camera phone, a smartphone, a personal digital assistant, a media player, a navigation device, an email device, a game console, a tablet, a wearable device, or any combination of these devices.

For a convenience of description, the above apparatus is divided into various units based on their functions for separate description. Of course, when implementing the embodiments of the present application, the functions of each unit can be implemented in the same or multiple software and/or hardware.

Those skilled in the art should understand that one or more embodiments of the present application may be provided as methods, systems, or computer program products. Therefore, one or more embodiments of the present application may take an embodiment form of a complete hardware embodiment, a complete software embodiment, or a combination of software and hardware embodiment. Moreover, the present application may take the form of the computer program product implemented on one or more computer available storage medias (including but not limited to a disk storage, a CD-ROM, an optical storage and the like) including the computer available program code.

The present application is described with reference to flowchart diagrams and/or block diagrams of the method, device (system), and computer program product according to the embodiments of the present application. It should be understood that, each process and/or block in the flowchart diagram and/or block diagram, as well as a combination of processes and/or blocks in the flowchart diagram and/or block diagram can be implemented by computer program instructions. These computer program instructions can be provided to the processors of general-purpose computers, specialized computers, embedded processors, or other programmable data processing device to generate a machine, enabling the instructions executed by the processor of the computers or other programmable data processing device to generate the apparatus for implementing the functions specified in one or more processes in the flowchart diagram and/or one or more blocks in the block diagram.

These computer program instructions can also be stored in a computer-readable memory that can guide the computer or other programmable data processing device to work in a specific way, so that the instructions stored in the computer-readable memory generate a manufacturing product including an instruction apparatus, where the instruction apparatus implements the functions specified in one or more processes in the flowchart diagram and/or one or more blocks in the block diagram.

These computer program instructions can also be loaded onto the computer or other programmable data processing device, enable to perform a series of operational steps on the computer or other programmable device to generate computer-implemented processing. Therefore, the instructions executed on the computer or other programmable device provide steps for implementing the functions specified in one or more processes in the flowchart diagram and/or one or more blocks in the block diagram.

In a typical configuration, a computing device includes one or more processors (CPU), an input/output interface, a network interface and a memory.

The memory may include a non-permanent memory, a random access memory (RAM), and/or a non-volatile memory in the computer-readable medium, such as a read-only memory (ROM) or a flash memory. The memory is an example of the computer-readable medium.

The computer-readable medium including permanent and non-permanent, movable and non-movable medium, which can be implemented by any method or technology for information storage. Information can be the computer-readable instruction, a data structure, a program module, or other data. Examples of a storage media for the computer include, but are not limited to, a phase change memory (PRAM), a static random access memory (SRAM), a dynamic random access memory (DRAM), other types of random access memory (RAM), the read-only memory (ROM), an electrically erasable programmable read-only memory (EEPROM), the flash memory or other memory technologies, an optical disc read-only memory (CD-ROM), a digital multifunctional optical disc (DVD) or other optical storage, magnetic cassette tapes, magnetic tape and disk storage or other magnetic storage devices, or any other non-transfer media that can be used to store the information that can be accessed by the computing device. According to a definition in this article, the computer-readable medium does not include a temporary computer-readable media (transitory media), such as modulated data signals and carriers.

It should also be further noted that, terms “include”, “contain” or any other variations thereof are intended to encompass a non-exclusive inclusion, such that a process, method, commodity, or device that includes a series of elements not only includes those elements, but also includes other elements that are not explicitly listed, or also includes the element inherent to such process, method, commodity, or device. Without further limitations, the element limited by a statement “include a . . . ” do not exclude an existence of other identical element in the process, method, commodity, or device that includes this element.

One or more embodiments of the present application may be described in general context of the computer-executable instructions executed by the computer, such as the program module. Generally, the program module includes routines, programs, objects, components, data structures and like that perform specific tasks or implement specific abstract data types. One or more embodiments of the present application can also be practiced in distributed computing environments, where tasks are executed by a remote processing device connected through a communication network in these distributed computing environments. In the distributed computing environment, the program module can be located on a local and remote computer storage medium, which include the storage device.

The various embodiments in the present application are described in a progressive manner, and the same and similar parts between respective embodiments can be referred to each other. Each embodiment focuses on differences from other embodiments. Especially for system embodiments, since they are basically similar to method embodiments, which is simply described. Please refer to a description section of the method embodiments for relevant information.

The above is only embodiments of this document and is not intended to limit it. For those skilled in the art, this document can have various changes and variations. Any modifications, equivalent replacements, improvements and the like made within spirits and principles of this document shall be included within a scope of the claims in this document.

What is claimed is:

1. A data processing method, comprising:
obtaining a matrix, the matrix comprising an eigenvalue corresponding to a data feature;
generating first evaluation data of the matrix according to the eigenvalue and position information of the eigenvalue in the matrix, the first evaluation data being dispersion of the eigenvalue in terms of distribution;
generating second evaluation data of the matrix according to the eigenvalue and constraints of the eigenvalue, the second evaluation data being a degree of approaching zero of the eigenvalue in terms of numerical;
performing a sparsity evaluation on the matrix according to the first evaluation data and the second evaluation data.

2. The method according to claim 1, wherein the generating the first evaluation data of the matrix according to the eigenvalue and the position information of the eigenvalue in the matrix, comprises:
for each vector in the matrix, determining the eigenvalue included in the vector according to the position information of the eigenvalue in the matrix;
determining eigenvalue fluctuation information of the vector according to the eigenvalue included in the vector;
generating the first evaluation data of the matrix according to the eigenvalue fluctuation information for each vector.

3. The method according to claim 2, wherein the determining the eigenvalue fluctuation information of the vector according to the eigenvalue included in the vector;
comprises:
determining a first amount of a non-zero eigenvalue among eigenvalues included in the vector;
performing a deduplication process on the non-zero eigenvalue corresponding to the vector, and determining a second amount of the non-zero eigenvalue after the deduplication process;
identifying a maximum eigenvalue and a minimum eigenvalue among the eigenvalues included in the vector;
determining the first amount, the second amount, the maximum eigenvalue, and the minimum eigenvalue as the eigenvalue fluctuation information of the vector.

4. The method according to claim 3, wherein the generating the first evaluation data of the matrix according to the eigenvalue fluctuation information for each vector, comprises:
for each vector in the matrix, determining eigenvalue distribution information of the vector according to the first amount and the second amount in the eigenvalue fluctuation information of the vector;
determining an eigenvalue fluctuation range of the vector according to the maximum eigenvalue and the minimum eigenvalue in the eigenvalue fluctuation information of the vector;
determining an eigenvalue dispersion degree of the vector according to the eigenvalue distribution information and the eigenvalue fluctuation range;
generating the first evaluation data of the matrix according to the eigenvalue dispersion degree for each vector and the number of vectors included in the matrix.

5. The method according to claim 2, wherein the generating the second evaluation data of the matrix according to the eigenvalue and the constraints of the eigenvalue, comprises:
for each vector in the matrix, determining an eigenvalue approaching zero degree of the vector according to the constraints of the eigenvalue and the eigenvalue included in the vector;
generating the second evaluation data of the matrix according to the eigenvalue approaching zero degree for each vector and the number of vectors included in the matrix.

6. The method according to claim 5, wherein the determining the eigenvalue approaching zero degree of the vector according to the constraints of the eigenvalue and the eigenvalue included in the vector, comprises:
determining an eigenvalue average and a median of the vector according to the eigenvalues included in the vector;
selecting a target eigenvalue from the eigenvalues included in the vector according to the constraints of the eigenvalue, a size relationship between the eigenvalue average and the median;
determining the eigenvalue approaching zero degree of the vector according to the target eigenvalue and the number of target eigenvalue.

7. The method according to claim 1, wherein the performing the sparsity evaluation on the matrix according to the first evaluation data and the second evaluation data, comprises:
comparing the first evaluation data with a dispersion threshold to obtain a first comparison result;
comparing the second evaluation data with an approaching zero degree threshold to obtain a second comparison result;
determining whether the matrix is a sparse matrix according to the first comparison result and the second comparison result.

8. The method according to claim 1, wherein after performing the sparsity evaluation on the matrix, the method further comprises:
determining a sparsity parameter of the matrix according to the first evaluation data and the second evaluation data;
performing a sparsity comparison on the matrix and a to-be-compared matrix according to the sparsity parameter.

9. A data processing apparatus, comprising:
a processor; and,
a memory arranged to store computer executable instructions, wherein the executable instructions are configured to be executed by the processor, and the processor is configured to:
obtain a matrix, the matrix comprising an eigenvalue corresponding to a data feature;
generate first evaluation data of the matrix according to the eigenvalue and position information of the eigenvalue in the matrix, the first evaluation data being dispersion of the eigenvalue in terms of distribution;
generate second evaluation data of the matrix according to the eigenvalue and constraints of the eigenvalue, the second evaluation data being a degree of approaching zero of the eigenvalue in terms of numerical;
perform a sparsity evaluation on the matrix according to the first evaluation data and the second evaluation data.

10. The apparatus according to claim 9, wherein the processor is further configured to:
for each vector in the matrix, determine the eigenvalue included in the vector according to the position information of the eigenvalue in the matrix;
determine eigenvalue fluctuation information of the vector according to the eigenvalue included in the vector;
generate the first evaluation data of the matrix according to the eigenvalue fluctuation information for each vector.

11. The apparatus according to claim 10, wherein the processor is further configured to:
determine a first amount of a non-zero eigenvalue among eigenvalues included in the vector;
perform a deduplication process on the non-zero eigenvalue corresponding to the vector, and determine a second amount of the non-zero eigenvalue after the deduplication process;
identify a maximum eigenvalue and a minimum eigenvalue among the eigenvalues included in the vector;
determine the first amount, the second amount, the maximum eigenvalue, and the minimum eigenvalue as the eigenvalue fluctuation information of the vector.

12. The apparatus according to claim 11, wherein the processor is further configured to:
for each vector in the matrix, determine eigenvalue distribution information of the vector according to the first amount and the second amount in the eigenvalue fluctuation information of the vector;
determine an eigenvalue fluctuation range of the vector according to the maximum eigenvalue and the minimum eigenvalue in the eigenvalue fluctuation information of the vector;
determine an eigenvalue dispersion degree of the vector according to the eigenvalue distribution information and the eigenvalue fluctuation range;
generate the first evaluation data of the matrix according to the eigenvalue dispersion degree for each vector and the number of vectors included in the matrix.

13. The apparatus according to claim 10, wherein the processor is further configured to:
for each vector in the matrix, determine an eigenvalue approaching zero degree of the vector according to the constraints of the eigenvalue and the eigenvalue included in the vector;
generate the second evaluation data of the matrix according to the eigenvalue approaching zero degree for each vector and the number of vectors included in the matrix.

14. The apparatus according to claim 13, wherein the processor is further configured to:
determine an eigenvalue average and a median of the vector according to the eigenvalues included in the vector;
select a target eigenvalue from the eigenvalues included in the vector according to the constraints of the eigenvalue, a size relationship between the eigenvalue average and the median;
determine the eigenvalue approaching zero degree of the vector according to the target eigenvalue and the number of target eigenvalue.

15. The apparatus according to claim 9, wherein the processor is further configured to:
compare the first evaluation data with a dispersion threshold to obtain a first comparison result;
compare the second evaluation data with an approaching zero degree threshold to obtain a second comparison result;
determine whether the matrix is a sparse matrix according to the first comparison result and the second comparison result.

16. The apparatus according to claim 9, wherein the processor is further configured to:
determine a sparsity parameter of the matrix according to the first evaluation data and the second evaluation data;
perform a sparsity comparison on the matrix and a to-be-compared matrix according to the sparsity parameter.

17. A non-transitory computer-readable storage medium, wherein the computer-readable storage medium is used to store computer executable instructions, and the executable instructions enable a computer to:
obtain a matrix, the matrix comprising an eigenvalue corresponding to a data feature;
generate first evaluation data of the matrix according to the eigenvalue and position information of the eigenvalue in the matrix, the first evaluation data being dispersion of the eigenvalue in terms of distribution;
generate second evaluation data of the matrix according to the eigenvalue and constraints of the eigenvalue, the second evaluation data being a degree of approaching zero of the eigenvalue in terms of numerical;
perform a sparsity evaluation on the matrix according to the first evaluation data and the second evaluation data.

18. The non-transitory computer-readable storage medium according to claim 17, wherein the executable instructions further enable the computer to:
for each vector in the matrix, determine the eigenvalue included in the vector according to the position information of the eigenvalue in the matrix;
determine eigenvalue fluctuation information of the vector according to the eigenvalue included in the vector;
generate the first evaluation data of the matrix according to the eigenvalue fluctuation information for each vector.

19. The non-transitory computer-readable storage medium according to claim 18, wherein the executable instructions further enable the computer to:
determine a first amount of a non-zero eigenvalue among eigenvalues included in the vector;
perform a deduplication process on the non-zero eigenvalue corresponding to the vector, and determine a second amount of the non-zero eigenvalue after the deduplication process;
identify a maximum eigenvalue and a minimum eigenvalue among the eigenvalues included in the vector;
determine the first amount, the second amount, the maximum eigenvalue, and the minimum eigenvalue as the eigenvalue fluctuation information of the vector.

20. The non-transitory computer-readable storage medium according to claim 19, wherein the executable instructions further enable the computer to:
for each vector in the matrix, determine eigenvalue distribution information of the vector according to the first amount and the second amount in the eigenvalue fluctuation information of the vector;
determine an eigenvalue fluctuation range of the vector according to the maximum eigenvalue and the minimum eigenvalue in the eigenvalue fluctuation information of the vector;
determine an eigenvalue dispersion degree of the vector according to the eigenvalue distribution information and the eigenvalue fluctuation range;
generate the first evaluation data of the matrix according to the eigenvalue dispersion degree for each vector and the number of vectors included in the matrix.
